(19) United States
(12) Patent Application Publication
(10) Pub. No.: US 2014/0159951 A1
(43) Pub. Date: Jun. 12, 2014

(54) Shoe-Embedded Emergency Positioning System

(71) Applicant: TERRY ELECTRONCS (S.Z) CO., LTD., ShenZhen City (CN)

(72) Inventors: John Gou, ShenZhen City (CN); Benrui Xu, ShenZhen City (CN)

(73) Assignee: TERRY ELECTRONCS (S.Z) CO., LTD., ShenZhen City (CN)

(21) Appl. No.: 13/709,624

(22) Filed: Dec. 10, 2012

(51) Int. Cl. G01S 19/17; G01S 19/42

(52) U.S. Cl. CPC G01S 19/17; G01S 19/42
USPC 342/357.25; 342/357.55

(57) ABSTRACT

A shoe body light-emitting device includes: a waterproof enclosure embedded on a shoe body and having a cavity; a control circuit embedded in the cavity and comprising circuit board and a motion actuated switch. The positive electrode of the circuit board is electrically coupled to the positive electrodes of light-emitting bodies and a power supply. The motion actuated switch is electrically connected with the circuit board for triggering the control circuit in response to motion of the shoe body, so that light-emitting bodies light in a predetermined way. A micro-current battery on the circuit board is used for supplying the light-emitting device with power. The light-emitting bodies may first flash N times simultaneously, then respectively flash twice sequentially, then respectively flash twice reversely, then respectively flash twice sequentially, and finally flash N times simultaneously (N is a natural number larger than or equal to 1).

### TECHNICAL FIELD

The present invention relates to a shoe-embedded positioning system, specifically to a shoe-embedded emergency positioning system for use in situation that people are besieged with hands trapped so that they can send emergency message to preset person by stamping their feet.

### BACKGROUND ART

At present, there are problems that the elders and children are missing or outdoor enthusiasts meet emergency outdoors; because of no accurate location information of these people, it is very inconvenient to look for the elders, children and the trapped outdoor enthusiasts, and some people even lose their lives because the rescue is late. Therefore, the satellite positioning system is commonly used to track and locate these special people, such that the relatives can acquire satellite positioning data of the respective people from computer through Internet and effectively provide help or rescue to protect their safety.

The common individual satellite positioning system is to equip GPS positioning system on the personal belongings like clothes, shoes and hats, and the most common way is to equip GPS positioning system shoes. The GPS positioning system equipped on shoes generally includes GPS positioning module, power supply and so on. The GPS positioning module can carry out accurate positioning through satellite and transmits the positioning data to the respective terminal equipment to realize the tracking and positioning functions. However, these shoes with GPS function can only provide satellite positioning data, people wearing the shoes cannot actively send distress signal to relatives or salvage service when meeting emergency or accidents, so it cannot meet the requirement of asking for help.

### SUMMARY OF THE INVENTION

The present invention aims at overcoming the disadvantages of the existing technique, except the tracking and positioning function, providing a shoe-embedded emergency positioning system through which the wearer can send emergency message to relatives or salvage service and even police by stamping their feet when meeting emergency or accidents with hands trapped.

The other goal of the present invention is that the wearer can send specific emergency message to specific people according to different situation for different emergency events. For example, when there is natural disaster or traffic accident that causes body injury, the wearer can send the emergency massage to relatives, emergency medical institutions and fire control department; when being kidnapped, the wearer can send the emergency message to relatives or police to provide information for rescue.

In order to achieve the goals, the present invention adopts the following technical solution:

A shoe-embedded emergency positioning system, comprising a satellite positioning device that collects satellite positioning data; a wireless communication device that sends the satellite positioning data and preset emergency message to communication devices of the preset contact person or the emergency organizations so as to transmit distress signal; antenna that is used to satellite positioning device and wireless communication device for sending or receiving data; central processing unit that collects real-time satellite positioning data, saves preset emergency message and communication information of the contact person or emergency organizations and triggers the wireless communication device according to the preset order so as to send the emergency message and satellite positioning data to communication devices of the preset contact person or the emergency organizations; emergency driven switch that is used to send the emergency order and drive the central processing unit to trigger the wireless communication device; and battery that is used to provide power supply for the satellite positioning device, wireless communication device and the central processing unit;

Wherein the preset order is that the shoe embedded with emergency device is struck for N+1 times within preset duration, and N is a natural number greater than 1.

A shoe-embedded emergency positioning system, comprising a satellite positioning device that collects satellite positioning data; a wireless communication device that sends the satellite positioning data and preset emergency message to communication devices of the preset contact person or the emergency organizations so as to transmit distress signal; antenna that is used to satellite positioning device and wireless communication device for sending or receiving data; central processing unit that collects real-time satellite positioning data, saves preset emergency message and communication information of the contact person or emergency organizations and triggers the wireless communication device according to the preset order so as to send the emergency message and satellite positioning data to communication devices of the preset contact person or the emergency organizations; emergency driven switch that is used to send the emergency order and drive the central processing unit to trigger the wireless communication device; data acquisition and identification device that connects the emergency driven switch and the central processing unit, collects emergency driven information within specific duration and identifies the information property, and the central processing unit triggers the wireless communication device so as to send the emergency message property and satellite positioning data to communication devices of the respective contact person or the emergency organizations; and battery that is used to provide power supply for the satellite positioning device, wireless communication device and the central processing unit;

Wherein the preset order is that the shoe embedded with emergency device is struck for N+1 times within preset duration, and N is a natural number greater than 1.

The satellite positioning device is the Global Positioning System.

The wireless communication device is GSM communication device.

The satellite positioning device and the wireless communication device are provided with a built-in antenna.

The preset contact person or the emergency organizations include relatives, salvage service and public arrangement organization.

The preset emergency message includes accident emergency message and crime emergency message.

The satellite positioning device, the wireless communication device, the central processing unit, the emergency driven switch and the battery are enclosed in one shell.

The emergency driven switch is a vibration switch.

Because of the above structure, if the personnel that need to be located wear the shoes equipped with the shoe-embedded emergency positioning system, their tracks can be known at any time, so that the elders and children will not be missing. And if the wearer meet emergency event with hands trapped and cannot call anyone for help, the wearer can stamp his/her feet for N+1 times within duration so the emergency message can be sent to the respective people, thus to ensure that the wearer can be rescued in short time for safety.

### BRIEF DESCRIPTION OF THE DRAWINGS

FIG. 1 is the principle block chart of the first embodiment of the present invention.

FIG. 2 is the principle block chart of the second embodiment of the present invention.

FIG. 3 is the structural schematic diagram of the present invention mounted on the shoe.

### DETAILED DESCRIPTION OF THE EMBODIMENTS

The following is the further detailed description of the present invention by combining the drawings and embodiments.

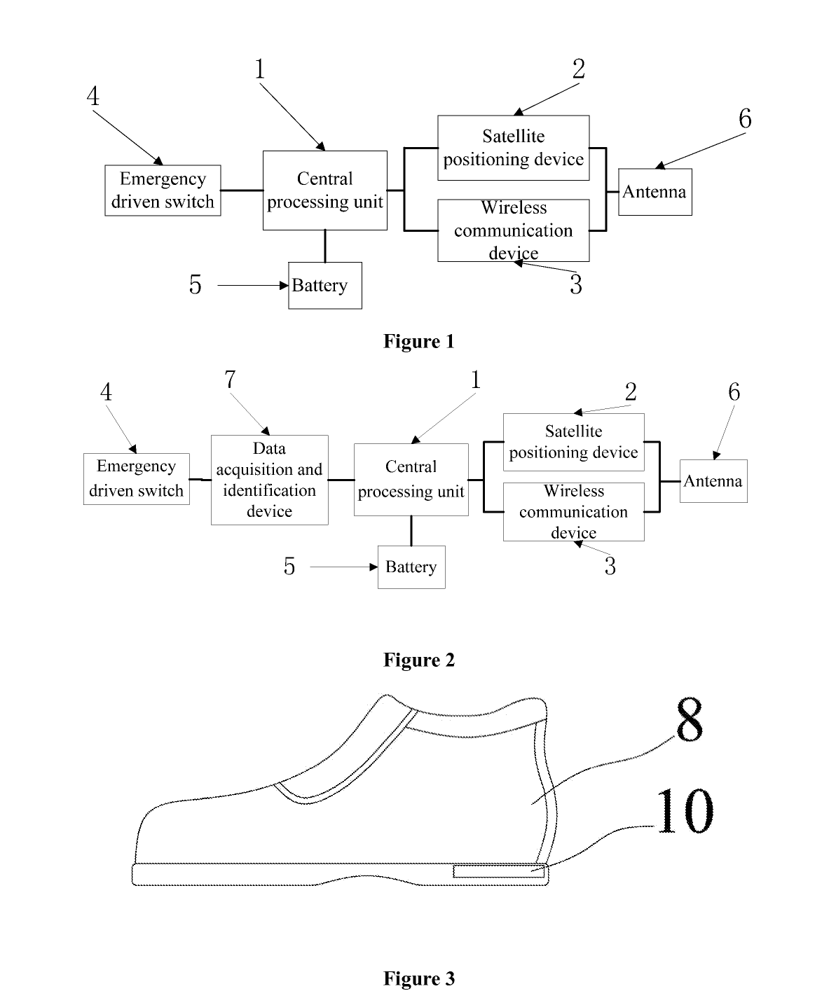

The first embodiment is as shown in the FIG. 1 and FIG. 3. A shoe-embedded emergency positioning system 10 which is mounted in the heel part of shoe 8, comprising central processing unit 1, satellite positioning device 2, wireless communication device 3 and emergency driven switch 4, battery 5 and antenna 6. The central processing unit 1 is the data processing center of the emergency positioning system 10, in which the preset emergency message and contact information of relatives, rescue organization or police department can be saved. The satellite positioning device 2 preferably uses the GPS connected with the antenna 6 to collect the satellite positioning data of the shoes' location and send the data to the central positioning unit 1. The wireless communication device 3 adopts GSM wireless communication device connected with the antenna 6, the wireless communication device is in duplex communication with the central positioning unit 1 and sends the satellite positioning data and emergency information to preset personnel like relatives, rescue organization or police department according to the order of central positioning unit 1. The emergency driven switch 4 is in communication with the central processing unit. The vibration switch is generally used as the emergency driven switch so as to sense the vibration of stamping and trigger central processing unit. When people wearing the shoes embedded with the emergency positioning system meet accident and cannot call anyone for help with hands trapped, they only need to stamp their feet for N+1 (N is a natural number greater than 1) times within specific duration (for example, 5 seconds), for example, 3 times, so that their relatives, rescue organization or police can save them; the central processing unit 1 receives the 3-time triggering from the emergency driven switch and sends the emergency message and satellite positioning data to communication devices of the preset contact person or organizations trough the wireless communication device 3, so as to guarantee that the trapped people can be saved in the shortest time. The battery 5 is used to provide power supply for the emergency positioning system to ensure the normal work. The whole emergency positioning system 10 is enclosed in a waterproof cover and mounted at the heel part of the sole (as shown in FIG. 3).

The second embodiment is as shown in the FIG. 2. A data acquisition and identification device 7 is added on the basis of the embodiment one. The central processing unit 1 categories the emergency message and categories the preset contact person into different property types so that the emergency message property can be corresponding to the contact person property. For example, the emergency message is categorized into common accident message and crime kidnapping message, and the contact person is categorized into common accident rescuer and crime rescuer. The data acquisition and identification device 7 can identify the triggering times of the emergency driven switch within preset duration and corresponds the different times to the message type saved in the central processing unit. When people wearing the shoes meet common accident and cannot call anyone for help with hands trapped, they can stamp their feet for three times within specific duration like five seconds. The data acquisition and identification device 7 identifies that there is only 3-time triggering within 5 seconds, it sends the common accident emergency order to the central processing unit 1 which sends the common accident emergency order and satellite positioning data to the respective relatives and rescue organization through the wireless communication device, so that they can be saved within shortest time. When the wearer stamps for N+1 (N is natural number greater than 2) times within specific time like 5 seconds, for example, 5 times, the data acquisition and identification device 7 identifies that there is 5-time triggering within 5 seconds, it sends the crime kidnapping accident emergency message to communication device of the policemen, so that the policeman can rescue according to specific situation to protect the safety of hostage.

What is claimed is:

1. A shoe-embedded emergency positioning system, comprising
a satellite positioning device that collects satellite positioning data;
a wireless communication device that sends the satellite positioning data and preset emergency message to communication devices of the preset contact person or the emergency organizations so as to transmit distress signal;
antenna that is used to satellite positioning device and wireless communication device for sending or receiving data;
central processing unit that collects real-time satellite positioning data, saves preset emergency message and communication information of the contact person or emergency organizations and triggers the wireless communication device according to the preset order so as to send the emergency message and satellite positioning data to communication devices of the preset contact person or the emergency organizations;
emergency driven switch that is used to send the emergency order and drive the central processing unit to trigger the wireless communication device;
and battery that is used to provide power supply for the satellite positioning device, wireless communication device and the central processing unit;
wherein the preset order is that the shoe embedded with emergency device is struck for N+1 times within preset duration, and N is a natural number greater than 1.

2. The shoe-embedded emergency positioning system according to claim 1, wherein the satellite positioning device is the Global Positioning System.

3. The shoe-embedded emergency positioning system according to claim 1, wherein the wireless communication device is GSM communication device.

4. The shoe-embedded emergency positioning system according to claim 1, wherein the satellite positioning device and the wireless communication device are provided with a built-in antenna.

5. The shoe-embedded emergency positioning system according to claim 1, wherein the satellite positioning device, the wireless communication device, the central processing unit, the emergency driven switch and the battery are enclosed in one shell.

6. The shoe-embedded emergency positioning system according to claim 1, wherein the emergency driven switch is a vibration switch.

7. A shoe-embedded emergency positioning system, comprising
a satellite positioning device that collects satellite positioning data;
a wireless communication device that sends the satellite positioning data and preset emergency message to communication devices of the preset contact person or the emergency organizations so as to transmit distress signal;
antenna that is used to satellite positioning device and wireless communication device for sending or receiving data;
central processing unit that collects real-time satellite positioning data, saves preset emergency message and communication information of the contact person or emergency organizations and triggers the wireless communication device according to the preset order so as to send the emergency message and satellite positioning data to communication devices of the preset contact person or the emergency organizations;
emergency driven switch that is used to send the emergency order and drive the central processing unit to trigger the wireless communication device;
data acquisition and identification device that connects the emergency driven switch and the central processing unit, collects emergency driven information within specific duration and identifies the information property, and the central processing unit triggers the wireless communication device so as to send the emergency message property and satellite positioning data to communication devices of the respective contact person or the emergency organizations;
and battery that is used to provide power supply for the satellite positioning device, wireless communication device and the central processing unit;
wherein the preset order is that the shoe embedded with emergency device is struck for N+1 times within preset duration, and N is a natural number greater than 1.

8. The shoe-embedded emergency positioning system according to claim 7, wherein the satellite positioning device is the Global Positioning System.

9. The shoe-embedded emergency positioning system according to claim 7, wherein the wireless communication device is GSM communication device.

10. The shoe-embedded emergency positioning system according to claim 7, wherein the satellite positioning device and the wireless communication device are provided with a built-in antenna.

11. The shoe-embedded emergency positioning system according to claim 7, wherein the preset contact person or the emergency organizations include relatives, salvage service and public arrangement organization.

12. The shoe-embedded emergency positioning system according to claim 7, wherein the preset emergency message includes accident emergency message and crime emergency message.

13. The shoe-embedded emergency positioning system according to claim 7, wherein the satellite positioning device, the wireless communication device, the central processing unit, the emergency driven switch and the battery are enclosed in one shell.

14. The shoe-embedded emergency positioning system according to claim 7, wherein the emergency driven switch is a vibration switch.
